(19) United States
(12) Patent Application Publication
(10) Pub. No.: US 2013/0212636 A1
(43) Pub. Date: Aug. 15, 2013

(54) ELECTRONIC DEVICE AND A METHOD OF SYNCHRONOUS IMAGE DISPLAY

(71) Applicant: Winstron Corporation, (US)

(72) Inventor: Ming-Fong Yeh, New Taipei City (TW)

(73) Assignee: WISTRON CORPORATION, New Taipei City (TW)

(21) Appl. No.: 13/709,101

(22) Filed: Dec. 10, 2012

(30) Foreign Application Priority Data
Feb. 15, 2012 (TW) 101104909

(51) Int. Cl. H04N 21/63

(52) U.S. Cl. CPC H04N 21/63
USPC 725/127

(57) ABSTRACT

The electronic device includes a display unit for displaying a frame, a frame information acquiring unit, and a digital media server electrically coupled to the frame information acquiring unit. The digital media server transmits a frame information acquiring command to the frame information acquiring unit for acquiring information associated with the frame that is currently displayed on the display unit and encodes the information thus acquired to generate a media data that is to be subsequently sent to a digital media renderer by the digital media server, and that, when decoded by the digital media renderer, generates a frame, which mirrors the frame currently displayed on the display unit.

### CROSS-REFERENCE TO RELATED APPLICATION

This application claims priority of Taiwanese Patent Application No. 101104909, filed on Feb. 15, 2012, the disclosure of which is incorporated herein by reference.

### BACKGROUND OF THE INVENTION

1. Field of the Invention

This invention relates to a digital media display technology, more particularly to an electronic device and a method of synchronous image display that supports DLNA/UPnP (digital living network alliance/universal plug and play) standard.

2. Description of the Related Art

Digital Living Network Alliance (DLNA) is a technical standard for establishing a standard communication platform on an existing network for supporting communications among portable electronic devices, consumer electronics, personal computers, etc. DLNA uses universal plug and play (UPnP), which is a technology for seamlessly connecting several digital electronic devices and enabling simply and robust connectivity that is free from complex setup procedures.

Further, DLNA mainly supports three kinds of electronic devices: first, a digital media server (DMS), such as a set-top box, a VCR (videocassette recorder), a PC (personal computer), a home theater apparatus provided with a storage device, etc., for providing digital media content; second, a digital media renderer (DMR), such as a digital TV, a digital monitor, a digital projector, etc., for playing digital media content received from a digital media server,; and third, a digital media controller (DMC), such as a smart phone, to serve as a remote controller that is capable of finding and assigning a digital media server to a digital media renderer and enabling the digital media renderer to play the digital media content provided by the digital media server.

Currently, the digital media server can only provide the digital media content to the digital media renderer in the form of a file. Consequently, video content currently being played on a digital media server, such as a personal computer, cannot be synchronously played on a digital media renderer, such as a digital monitor.

### SUMMARY OF THE INVENTION

Therefore, the object of the present invention is to provide an electronic device and a method of synchronous image display that supports substantially synchronous displays of the same image on a digital media server and a digital media renderer.

According to a first aspect of this invention, there is provided an electronic device capable of communicating under a network standard, and adapted to be assigned by a digital media controller (DMC) supporting the same network standard to a digital media renderer (DMR) that supports the same network standard. The digital media renderer is part of an imaging device that further includes an image output unit. The electronic device includes a display unit for displaying a frame, a frame information acquiring unit, and a digital media server (DMS) electrically coupled to the frame information acquiring unit. The digital media server is capable of transmitting a frame information acquiring command to the frame information acquiring unit upon receipt of a media content request from the digital media renderer of the imaging device. In response to the frame information acquiring command, the frame information acquiring unit acquires information associated with the frame that is currently displayed on the display unit and encodes the information thus acquired to generate a media data that is to be subsequently sent to the digital media renderer by the digital media server, and that, when decoded by the digital media renderer, generates a frame, which mirrors the frame currently displayed on the display unit, and which is to be outputted by the image output unit of the imaging device.

According to a second aspect of this invention, there is provided an electronic device capable of communicating under a network standard, and adapted to communicate with a digital media renderer (DMR) that supports the same network standard. The digital media renderer is part of an imaging device that further includes an image output unit. The electronic device includes a display unit for displaying a frame, a frame information acquiring unit, a digital media server (DMS) electrically coupled to the frame information acquiring unit, and a digital media controller (DMC) for assigning the digital media server to the digital media renderer (DMR). The digital media server is capable of transmitting a frame information acquiring command to the frame information acquiring unit upon receipt of a media content request from the digital media renderer. In response to the frame information acquiring command, the frame information acquiring unit acquires information associated with the frame that is currently displayed on the display unit and encodes the information thus acquired to generate a media data that is to be subsequently sent to the digital media renderer by the digital media server, and that, when decoded by the digital media renderer, generates a frame, which mirrors the frame currently displayed on the display unit, and which is to be outputted by the image output unit of the imaging device.

According to a third aspect of this invention, there is provided a method of synchronous image display adapted to be used by an electronic device, a digital media controller and a digital media renderer that support the same network standard. The method includes the steps of:

(A) providing a frame information acquiring unit and a digital media server (DMS) to the electronic device;

(B) when the digital media server is assigned to the digital media renderer by the digital media controller, and when the digital media server receives a media content request from the digital media renderer, configuring the digital media server to transmit a frame information acquiring command to the frame information acquiring unit;

(C) configuring the frame information acquiring unit to acquire information associated with a frame that is currently displayed by the electronic device and encode the information thus acquired to generate a media data upon receipt of the frame information acquiring command;

(D) configuring the digital media server to transmit the media data to the digital media renderer; and

(E) configuring the digital media renderer to decode the media data so as to generate a frame, which mirrors the frame currently displayed by the electronic device, and which is to be outputted for image display.

According to a forth aspect of this invention, there is provided a method of synchronous image display adapted to be used by an electronic device and a digital media renderer that support the same network standard. The method includes the steps of:

(A) providing a frame information acquiring unit, a digital media server (DMS) and a digital media controller (DMC) to the electronic device;

(B) when the digital media controller assigns the digital media server to the digital media renderer, and when the digital media server receives a media content request from the digital media renderer, configuring the digital media server to transmit a frame information acquiring command to the frame information acquiring unit;

(C) configuring the frame information acquiring unit to acquire information associated with a frame that is currently displayed by the electronic device and encode the information thus acquired to generate a media data upon receipt of the frame information acquiring command;

(D) configuring the digital media server to transmit the media data to the digital media renderer; and

(E) configuring the digital media renderer to decode the media data so as to generate a frame, which mirrors the frame currently displayed by the electronic device, and which is to be outputted for image display.

### BRIEF DESCRIPTION OF THE DRAWINGS

Other features and advantages of the present invention will become apparent in the following detailed description of the embodiments of this invention, with reference to the accompanying drawings, in which:

FIG. 1 is a block diagram of an electronic device according to the first embodiment of this invention;

FIG. 2 is a flow chart of a method of synchronous image display according to the first embodiment of this invention;

FIG. 3 is a block diagram of the electronic device according to the second embodiment of this invention; and

FIG. 4 is a flow chart illustrating an alternative procedure of the method for when the frame displayed on the electronic device is not one of a plurality of consecutive frames of a video.

### DETAILED DESCRIPTION OF THE EMBODIMENTS

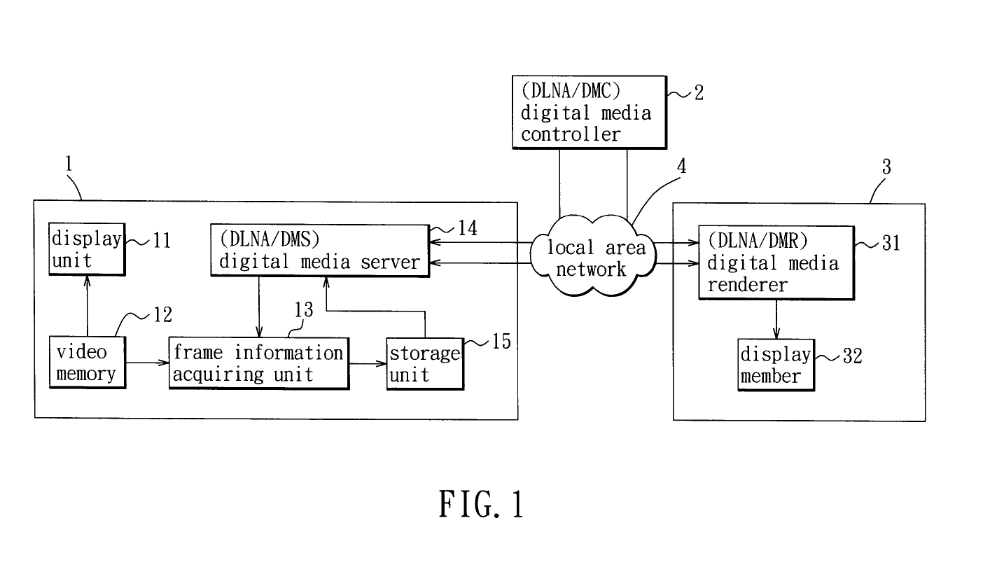

FIG. 1 shows an electronic device 1 for displaying an image on an imaging device 3 according to a first embodiment of this invention. In the first embodiment, the electronic device 1 is capable of communicating under a network standard of DLNA/UPnP (digital living network alliance/universal plug and play) over a local area network (LAN), such as a wired network (e.g., Ethernet) or a wireless network (e.g., Wi-Fi). The electronic device 1, which can for example be a personal computer, is adapted to be assigned by a digital media controller (DMC) 2 supporting the same network standard to the imaging device 3. The imaging device 3 may for example be a digital television and includes a digital media renderer (DMR) 31 and an image output unit 32. In this embodiment, the image output unit 32 is a display member. In this embodiment, the electronic device 1 includes a display unit 11 for displaying a frame, a video memory 12, a frame information acquiring unit 13, a digital media server (DMS) 14, and a storage unit 15. The video memory 12 is electrically coupled to the display unit 11 and the frame information acquiring unit 13, and stores therein information associated with the frame that is currently displayed on the display unit 11. The digital media server 14 is electrically coupled to the frame information acquiring unit 13, and is capable of transmitting a frame information acquiring command to the frame information acquiring unit 13 upon receipt of a media content request, which is transmitted from the digital media renderer 31 of the imaging device 3 over a local area network 4. In response to the frame information acquiring command, the frame information acquiring unit 13 acquires the information associated with the frame that is currently displayed on the display unit 11 from the video memory 12, and encodes the information thus acquired to generate a media data that is to be subsequently sent to the digital media renderer 31 by the digital media server 14, and that, when decoded by the digital media renderer 31, generates a frame, which mirrors the frame currently displayed on the display unit 11, and which is to be outputted by the image output unit 32 of the imaging device 3. The storage unit 15 is electrically coupled to the frame information acquiring unit 13 for storing the media data generated by the frame information acquiring unit 13, and is accessible by the digital media server 14 to obtain the media data for subsequent transmission to the digital media renderer 31 by the digital media server 14.

The digital media controller 2 can be implemented by a remote control unit or be built in a smart terminal device, such as a smart phone, equipped with a basic operating interface. The digital media controller 2 is capable of searching the local area network for electronic devices that are provided with digital media servers and electronic devices that are provided with digital media renderers, and is further capable of assigning one electronic device provided with a digital media server to one electronic device provided with a digital media renderer so as to establish a connection between the digital media renderer and the digital media server, and to enable the digital media renderer to play media data from the digital media server of the electronic device assigned thereto by the digital media controller 2.

According to the described control mechanism of the digital media controller 2, when the display unit 11 of the electronic device 1 displays consecutive frames of a video, if it is desired to have the image currently displayed on the display unit 11 of the electronic device 1 displayed on the imaging device 3, a user can use the digital media controller 2 to search for the electronic device 1 (since the search involves techniques that are well known to those skilled in the art, the same will be omitted herein for the sake of brevity), and to assign the digital media server 14 of the electronic device 1 to the digital media renderer 31 of the searched imaging device 3. Specifically, the digital media renderer 31 will receive from the digital media controller 2 an access command specifying a path to the digital media server 14. According to the access command, the digital media renderer 31 subsequently establishes a connection with the digital media server 14 and sends a media content request to the digital media server 14. The media content request contains a media data format that is supported by the digital media renderer 31. It should be noted herein that the digital media controller 2 may be able to acquire the media data format supported by the digital media renderer 31, and thus, instead of the digital media renderer 31, the digital media controller 2 may also serve to inform the digital media server 14 of the media data format supported by the digital media renderer 31.

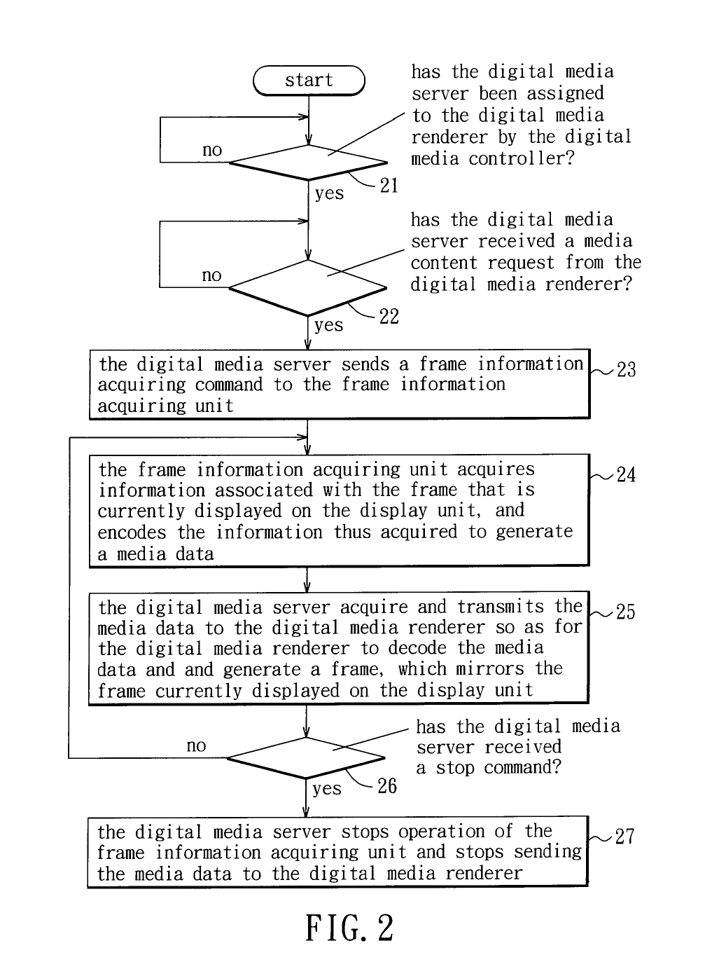

FIG. 2 shows the method of synchronous image display according to the first embodiment of this invention. In step 21, it is determined whether the digital media server 14 has been assigned to the digital media renderer 31 by the digital media controller 2. In the affirmative, the process goes to step 22, where it is determined whether the digital media server 14 receives a media content request from the digital media renderer 31; otherwise, the process returns to step 21. The process proceeds to when the determination of step 22 is affirmative, and returns to step 22 when otherwise. In step 23, the digital media server 14 transmits, to the frame information acquiring unit 13, a frame information acquiring command, which specifies the media data format that is supported by the digital media renderer 31. Subsequently, in step 24, in response to the frame information acquiring command, the frame information acquiring unit 13 acquires the information associated with the frame that is currently displayed on the display unit 11 from the video memory 12, and encodes the information thus acquired to generate a media data that complies with the media data format and that is subsequently stored in the storage unit 15. Next, in step 25, the digital media server 14 acquire the media data from the storage unit 15, and transmits the same to the digital media renderer 31 over the local area network 4 so as for the digital media renderer 31 to decode the media data and to generate a frame, which mirrors the frame currently displayed on the display unit 11, and which is to be outputted by the image output unit 32 of the imaging device 3. In this embodiment, the frame is displayed on the display member 32.

In addition, when the user uses the digital media controller 2 to control the digital media renderer 31 to stop the synchronous display, the digital media renderer 31 sends a stop command to the digital media server 14. Therefore, in step 26, it is determined whether the digital media server 14 receives the stop command. In the affirmative, the digital media server 14 stops operation of the frame information acquiring unit 13 and stops sending the media data to the digital media renderer 31 in step 27; otherwise, the process goes back to step 24. In other words, steps 24 and 25 are repeated until the digital media server 14 receives the stop command from the digital media renderer 31.

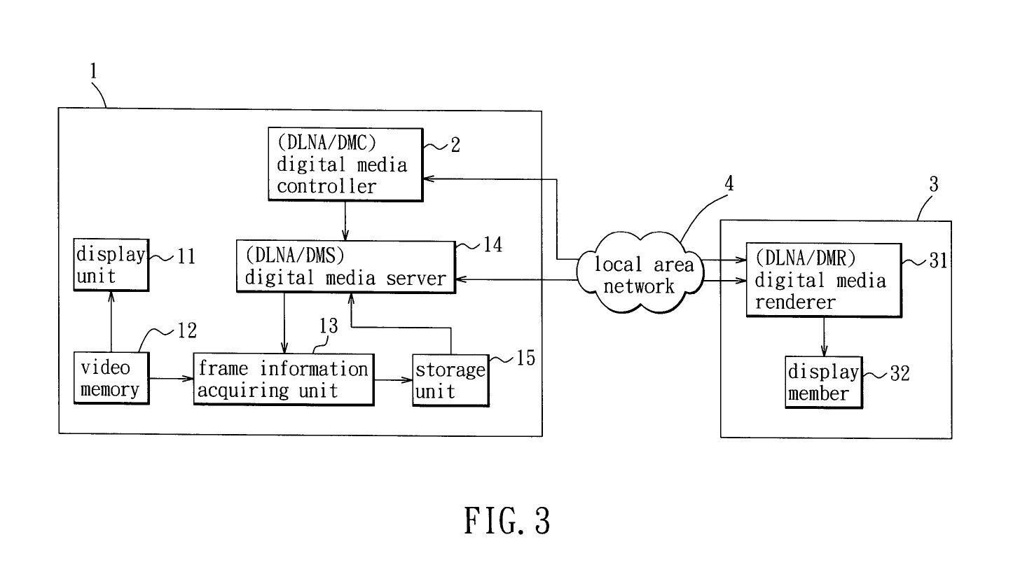

FIG. 3 shows an electronic device 1 for displaying an image on a imaging device 3 according to a second embodiment of this invention. The second embodiment is similar to the first embodiment, and only differs from the first embodiment in that the digital media controller 2 is integrated within the electronic device 1 along with the digital media server 14 and the frame information acquiring unit 13. Therefore, the user can omit the procedure of searching the electronic device 1 by using the digital media controller 2. When it is desired to concurrently display, on the image output unit 32 of the imaging device 3, the frame that is currently displayed on the display unit 11 of the electronic device 1, the user only needs to control the digital media controller 2 to designate the imaging device 3 as the media output terminal, and the path to the digital media server 14 will be sent by the digital media controller 2 via the local area network 4 to the digital media renderer 31 of the imaging device 3. The rest of the operation is identical to the first embodiment, and description of the same will be omitted herein for the sake of brevity.

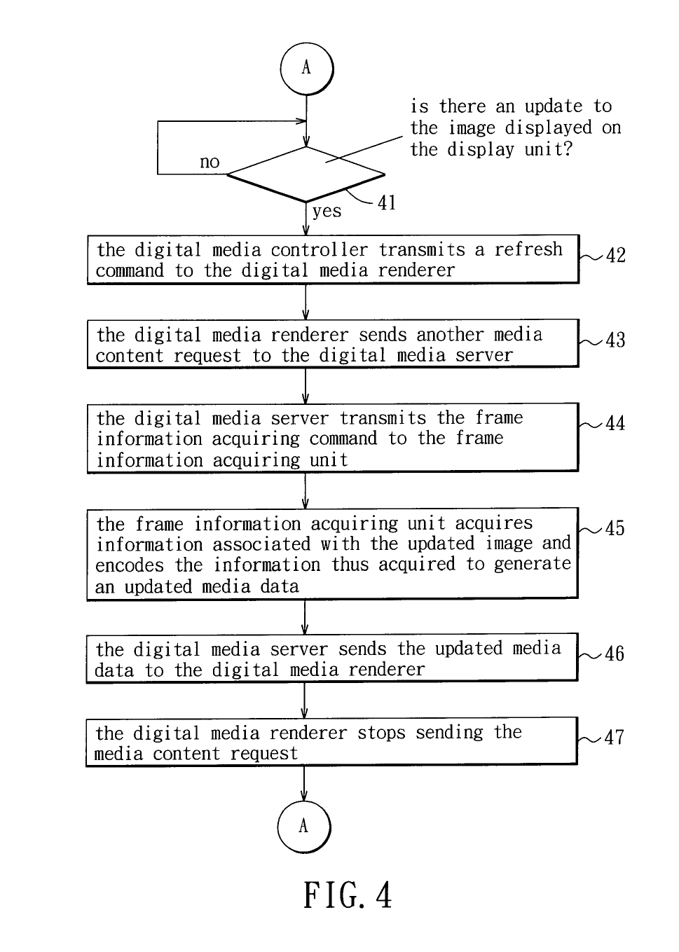

Moreover, to enhance performance and to reduce network flow and save bandwidth, when the frame that is currently displayed on the display unit 11 of the electronic device 1 is not one of a plurality of consecutive frames of a video, but an image of a Microsoft® Word file, or a Microsoft® PowerPoint file, etc., if concurrent display of the same on the image output unit 32 is desirable, it is not necessary to repeatedly acquire the information of the frame that is currently displayed on the display unit 11 at the frame rate of the display unit 11, but is only necessary to acquire the information of the frame whenever there is an update to the image displayed. Accordingly, the digital media controller 2 may include a detecting module (not shown) that is capable of detecting that the image displayed on the display unit 11 has been updated, i.e., that a subsequent frame differs from a previous frame. Alternatively, the digital media controller 2 may detect whether the image currently displayed on the display unit 11 has been updated through a feedback from the frame information acquiring unit 13, which indicates that the information associated with the frame as stored in the video memory 12 has changed. Therefore, in either case, with reference to FIG. 4, it is determined in step 41 whether there is an update to the image displayed on the display unit 11. For example, a cursor has been moved in the image. In the affirmative, the process proceeds to step 42; otherwise, the process goes back to step 41. In step 42, the digital media controller 2 transmits a refresh command to the digital media renderer 31.Subsequently, in step 43, in response to the refresh command, the digital media renderer 31 transmits another media content request to the digital media server 14. Next, in step 44, the digital media server 14 transmits the frame information acquiring command to the frame information acquiring unit 13. Then, in step 45, the frame information acquiring unit 13 acquires information associated with the updated image, i.e., the subsequent/different frame from the video memory 12 and encodes the information thus acquired to generate an updated media data. In step 46, the digital media server 14 sends the updated media data to the digital media renderer 31. In step 47, the digital media renderer 31 stops sending the media content request to the digital media server 14, and the process goes back to step 41.

To sum up, this invention provides an electronic device 1 provided with a frame information acquiring unit 13 for acquiring information associated with the displayed image on the display unit 11 on a per frame basis. The information can be subsequently transmitted to a digital media renderer 31 of an imaging device 3 at ease so as for a image output unit 32 of the imaging device 3 to immediately and substantially synchronously reproduce an identical image thereon.

While the present invention has been described in connection with what are considered the most practical embodiments, it is understood that this invention is not limited to the disclosed embodiments but is intended to cover various arrangements included within the spirit and scope of the broadest interpretation and equivalent arrangements.

What is claimed is:

1. An electronic device capable of communicating under a network standard, and adapted to be assigned by a digital media controller (DMC) supporting the same network standard to an imaging device including a digital media renderer (DMR) that supports the same network standard, the digital media renderer being part of an imaging device that further includes an image output unit, said electronic device comprising:
a display unit for displaying a frame;
a frame information acquiring unit; and
a digital media server (DMS) electrically coupled to said frame information acquiring unit, and capable of transmitting a frame information acquiring command to said frame information acquiring unit upon receipt of a media content request from the digital media renderer of the imaging device;
wherein, in response to the frame information acquiring command, said frame information acquiring unit acquires information associated with the frame that is currently displayed on said display unit and encodes the information thus acquired to generate a media data that is to be subsequently sent to the digital media renderer by said digital media server, and that, when decoded by the digital media renderer, generates a frame, which mirrors the frame currently displayed on said display unit, and which is to be outputted by the image output unit of the imaging device.

2. The electronic device as claimed in claim 1, further comprising:
a video memory coupled electrically to said display unit and said frame information acquiring unit, and storing therein the information associated with the frame that is currently displayed on said display unit; and
a storage unit coupled electrically to said frame information acquiring unit for storing the media data generated by said frame information acquiring unit, and accessible by said digital media server to obtain the media data for subsequent transmission to the digital media renderer by said digital media server.

3. The electronic device as claimed in claim 1, wherein:
the media content request sent by the digital media renderer to said digital media server contains a media data format that is supported by the digital media renderer;
said digital media server transmits the frame information acquiring command along with the media data format to said frame information acquiring unit; and
the media data generated by said frame information acquiring unit conforms to the media data format.

4. The electronic device as claimed in claim 1, wherein:
said digital media server further receives a media data format supported by the digital media renderer from the digital media controller;
said digital media server transmits the frame information acquiring command along with the media data format to said frame information acquiring unit; and
the media data generated by said frame information acquiring unit conforms to the media data format.

5. The electronic device as claimed in claim 1, wherein the network standard is the DLNA/UPnP (digital living network alliance/universal plug and play) standard.

6. An electronic device capable of communicating under a network standard, and adapted to communicate with a digital media renderer (DMR) that supports the same network standard, the digital media renderer being part of an imaging device that further includes an image output unit, said electronic device comprising:
a display unit for displaying a frame;
a frame information acquiring unit;
a digital media server (DMS) electrically coupled to said frame information acquiring unit; and
a digital media controller (DMC) for assigning said digital media server to the digital media renderer (DMR);
wherein said digital media server is capable of transmitting a frame information acquiring command to said frame information acquiring unit upon receipt of a media content request from the digital media renderer; and
wherein, in response to the frame information acquiring command, said frame information acquiring unit acquires information associated with the frame that is currently displayed on said display unit and encodes the information thus acquired to generate a media data that is to be subsequently sent to the digital media renderer by said digital media server, and that, when decoded by the digital media renderer, generates a frame, which mirrors the frame currently displayed on said display unit, and which is to be outputted by the image output unit of the imaging device.

7. The electronic device as claimed in claim 6, further comprising:
a video memory coupled electrically to said display unit and said frame information acquiring unit, and storing therein the frame that is currently displayed on said display unit, the frame being one of a plurality of consecutive frames of a video; and
a storage unit coupled electrically to said frame information acquiring unit for storing the media data generated by said frame information acquiring unit, and accessible by said digital media server to obtain the media data for subsequent transmission to the digital media renderer by said digital media server.

8. The electronic device as claimed in claim 7, wherein:
said digital media controller is able to detect whether a subsequent frame displayed on said display unit differs in content from a previous frame displayed on said display unit through a feedback from said frame information acquiring unit that the information associated with the frame as stored in said video memory has changed;
said digital media controller transmits a refresh command to the digital media renderer once said digital media controller detects that a subsequent frame differs in content from a previous frame;
in response to the refresh command, the digital media renderer transmits another media content request to said digital media server for said digital media server to transmit the frame information acquiring command to said frame information acquiring unit so as to acquire information associated with the subsequent frame and encode the information thus acquired to generate an updated media data that is to be subsequently sent to the digital media renderer by said digital media server, and that, when decoded by the digital media renderer, generates a frame, which mirrors the subsequent frame.

9. The electronic device as claimed in claim 6, wherein:
the media content request sent by the digital media renderer to said digital media server contains a media data format that is supported by the digital media renderer;
said digital media server transmits the frame information acquiring command along with the media data format to said frame information acquiring unit; and
the media data generated by said frame information acquiring unit conforms to the media data format.

10. The electronic device as claimed in claim 6, wherein:
said digital media controller transmits a media data format that is supported by the digital media renderer to said digital media server;
said digital media server transmits the frame information acquiring command along with the media data format to said frame information acquiring unit; and
the media data generated by said frame information acquiring unit conforms to the media data format.

11. The electronic device as claimed in claim 6, wherein:
said digital media controller includes a detecting module that is capable of detecting that the information associated with the frame displayed on said display unit has been updated;
said digital media controller transmits a refresh command to the digital media renderer once said detecting module detects that a subsequent frame differs in content from a previous frame;
in response to the refresh command, the digital media renderer transmits another media content request to said digital media server for said digital media server to transmit the frame information acquiring command to said frame information acquiring unit so as to acquire the information associated with the subsequent frame and encode the information thus acquired to generate an updated media data that is to be subsequently sent to the digital media renderer by said digital media server, and that, when decoded by the digital media renderer, generates a frame, which mirrors the subsequent frame.

12. The electronic device as claimed in claim 6, wherein the network standard is the DLNA/UPnP (digital living network alliance/universal plug and play) standard.

13. A method of synchronous image display adapted to be used by an electronic device, a digital media controller and a digital media renderer that support the same network standard, the method comprising the steps of:
(A) providing a frame information acquiring unit and a digital media server (DMS) to the electronic device;
(B) when the digital media server is assigned to the digital media renderer by the digital media controller, and when the digital media server receives a media content request from the digital media renderer, configuring the digital media server to transmit a frame information acquiring command to the frame information acquiring unit;
(C) configuring the frame information acquiring unit to acquire information associated with a frame that is currently displayed by the electronic device and encode the information thus acquired to generate a media data upon receipt of the frame information acquiring command;
(D) configuring the digital media server to transmit the media data to the digital media renderer; and
(E) configuring the digital media renderer to decode the media data so as to generate a frame, which mirrors the frame currently displayed by the electronic device, and which is to be outputted for image display.

14. A method of synchronous image display adapted to be used by an electronic device and a digital media renderer that support the same network standard, the method comprising the steps of:
(A) providing a frame information acquiring unit, a digital media server (DMS) and a digital media controller (DMC) to the electronic device;
(B) when the digital media controller assigns the digital media server to the digital media renderer, and when the digital media server receives a media content request from the digital media renderer, configuring the digital media server to transmit a frame information acquiring command to the frame information acquiring unit;
(C) configuring the frame information acquiring unit to acquire information associated with a frame that is currently displayed by the electronic device and encode the information thus acquired to generate a media data upon receipt of the frame information acquiring command; (D) configuring the digital media server to transmit the media data to the digital media renderer; and
(E) configuring the digital media renderer to decode the media data so as to generate a frame, which mirrors the frame currently displayed by the electronic device, and which is to be outputted for image display.
